(19) United States
(12) Patent Application Publication
(10) Pub. No.: US 2013/0236243 A1
(43) Pub. Date: Sep. 12, 2013

(54) Connectors for Furniture and Other Objects

(71) Applicants: Andrew Ray Personette, Brooklyn, NY (US); Matthew Aron Tyson, Brookyn, NY (US); Kallie Rae Weinkle, Brooklyn, NY (US); Wuthichai Leelavoravong, Bangkok (TH)

(72) Inventors: Andrew Ray Personette, Brooklyn, NY (US); Matthew Aron Tyson, Brookyn, NY (US); Kallie Rae Weinkle, Brooklyn, NY (US); Wuthichai Leelavoravong, Bangkok (TH)

(73) Assignee: EcoSystems Brand, LLC, Brooklyn, NY (US)

(21) Appl. No.: 13/696,257

(22) PCT Filed: May 4, 2011
(86) PCT No.: PCT/US11/35199

§ 371 Date: Apr. 30, 2013

Related U.S. Application Data
(60) Provisional application No. 61/331,729, filed on May 5, 2010.

(51) Int. Cl. F16B 12/20

(52) U.S. Cl. CPC F16B 12/20
USPC 403/345

(57) ABSTRACT

In various embodiments, the present invention provides one or more connectors of adjoining panels allowing for tool free assembly of furniture or other objects and a method using a connector with a panel to construct furniture and other objects. Each connector has a minimum of one U-shaped prong, where the depth of the opening on the prong is configured to receive a portion of a panel. The use of an intermediary element can be implemented to increase the friction coefficient between a panel member and connector.

### CROSS-REFERENCE TO RELATED APPLICATION

This application is a national stage application of PCT/US2011/035199 filed May 4, 2011, which claims priority to U.S. 61/331,729, filed May 5, 2010, and claims the benefit of both of the afore-referenced applications and incorporates by reference their entire disclosures.

### FIELD OF THE INVENTION

The present invention pertains to the field of furniture assembly.

### BACKGROUND OF THE INVENTION

Manufacturers, shippers and retailers know that when a piece of furniture is assembled, it often takes up more space in their warehouses, shipping containers and showrooms than when it is unassembled. The need for increased space can lead to increased shipping and storage costs. Thus not surprisingly, for quite some time there has been a movement to sell furniture in its unassembled state, thereby allowing for more efficient transport and storage of the furniture prior to use.

Unfortunately, if the manufacturer, shipper or retailer does not assemble the furniture, then someone else must do it. Typically in these circumstances, the consumer is the person who is responsible for assembling the furniture, and must either do it himself or herself, or arrange for someone else to do it for him or her.

When furniture is sold unassembled, it may come as part of a kit that contains both the panels that will form the desired assembled product and certain hardware, such as screws, nails, nuts and bolts to connect the panels. When sold in these kits, the furniture may be referred to as “ready to assemble.” However in commonly known applications, in order to assemble “ready to assemble” furniture, the consumer may need to employ one more various tools such as a hammer, a wrench, a flat head screwdriver, a Phillips-head screwdriver, a drill or one or more Allen keys. Some vendors expect consumers of these products to own and to use their own tools when assembling furniture from kits, while other vendors provide some or all of the tools in their kits.

When using these ready to assemble kits, too often consumers find themselves having made irreversible mistakes when they misalign panels and/or hardware, inadvertently use the incorrect screw or nail, strip the threading of a screw, splinter or scratch panels, or otherwise damage the furniture or render it unstable due to improper assembly. The occurrence of any one or more of the aforementioned mistakes may cause a consumer to be dissatisfied with his or her furniture acquisition.

Thus, there is a need for devices, methods and systems that address one or more of the following issues: reduction of the complexity of assembling items; reduction or elimination of the use of additional tools and hardware; providing the ability to assemble and to dissemble the components of the furniture without impacting the ability to reuse those components; and decreasing the likelihood of damaging the furniture when putting it together.

### SUMMARY OF THE INVENTION

The present invention is directed to devices for use in the assembly of furniture, kits that contain these devices, furniture that may be assembled from these devices and methods for assembling furniture using these devices.

According to a first embodiment, the present invention is directed to a device for connecting a plurality of panels, said device comprising a first U-shaped prong and a second U-shaped prong, wherein each of the first U-shaped prong and the second U-shaped prong has a cavity with an upper inner width and a lower inner width, wherein the upper inner width is smaller than the lower inner width.

According to a second embodiment, the present invention is directed to a device for connecting a plurality of panels, said device comprising a first engagement structure and a second engagement structure, wherein the first engagement structure comprises a U-shaped prong, wherein the U-shaped prong comprises a cavity that has an upper inner width and a lower inner width, wherein the upper inner width is smaller than the lower inner width and the second engagement structure is either capable of being reversibly associated with a panel or is capable of being non-reversibly associated with a panel of the present invention.

Through the various embodiments of the present invention one may make and use connectors (also referred to herein as devices) to link adjoining panels. In some embodiments, these connectors allow for tool free assembly of furniture or other objects and/or assembly without nails, screws or other hardware that provides for the irreversible, near permanent or difficult to reverse association of a device and panel(s). However, a consumer may elect to use tools and additional hardware to provide further reinforcement of connection between any two or more panels or any device and panel. The term “consumer” is used for convenience and unless otherwise specified or apparent from context is not limited to an end-user of the product.

In each connector, which has a minimum of one U-shaped prong, the depth of the opening of the prong, which may be referred to as a cavity, may be designed to suit the application in which it will be used. When there are a plurality of U-shaped prongs, all of the cavities may be the same size and shape or each cavity may have different dimensions, or any subset (e.g., two of three, two of four, three of four, two of five, three of five, four of five, two of six, three of six, four of six, five of six, etc.) of the cavities may have the same size and/or shape. As persons of ordinary skill in the art will appreciate, the size and the shape of the cavity should be designed in order to receive and to retain a portion of a panel.

The device may be designed such that when a sufficient force is exerted on the inner surfaces of a prong, the width of the prong can expand. For example, when a panel is inserted in the prong, the width of the panel may be greater than the upper inner width of the prong and either the same as, approximately the same as, slightly smaller or slightly greater than the lower inner width, and thereby cause the distance between the sides of the two prongs at the upper inner width to expand and to approach that of the width of the lower inner width, which itself may either be the same as it was prior to insertion of the panel or slightly larger upon insertion of the panel. Because the upper inner width is smaller than the lower inner width, when then panel has a uniform thickness over the location of insertion, even if the cavity expands over the entire range, it will expand more over the upper inner width than the lower inner width.

In certain embodiments, one may use one or more intermediary elements to increase the coefficient of friction between connectors and panels. An intermediary element may be attached to the device or the panel prior to insertion. Additionally, one could attach intermediary elements to both the device and to the panel so that when the panel in inserted the two intermediary elements are in contact with each other.

The various embodiments may, for example, be used in office or home furnishings, storage structures, supporting structures, displays, wall/room dividers, wall panels, ceiling panels, architectural surfaces, windows, ceilings and roofs. They may also be used in other applications such as applications in which one prong of a structure is connected to a panel and another prong is free to hold cables, hangers or clothing such as coats. In these applications, the prongs may be modified, exist in different forms or contain add-ons that facilitate their use in these other applications. For example, they may contain a hook, a groove or a hole or a combination thereof.

### BRIEF DESCRIPTION OF THE FIGURES

FIG. 1 is a representation of a device of the present invention with two prongs that show an internal angle of 160 degrees and an external angle of 200 degrees.

FIG. 2 is a representation of a device of the present invention that has two prongs at a corner showing an internal angle of 100 degrees and an external angle of 260 degrees.

FIG. 3 is a representation of another device of the present invention. The device has three prongs with angles between the first and second prongs of 100 degrees, between the second and third prongs of 100 degrees and between the first and third prongs of 160 degrees.

FIGS. 4A-4H13 combine to form a representation of a kit of the present invention and instructions for the step by step assemblage of a piece of furniture according to the present invention.

FIGS. 5A-1 to 5A-3 show a perspective view of each of the three types of devices of FIGS. 1 to 3. FIG. 5A-4 shows an additional device of the present invention. FIG. 5B shows how to insert a device over an intermediary element that is attached to a panel.

FIG. 6 shows a piece of furniture that forms a desk and shelves.

FIG. 7 shows a piece of furniture that forms a desk

### DETAILED DESCRIPTION OF THE INVENTION

According to a first embodiment, the present invention is directed to a device for connecting a plurality of panels. The device, which may also be referred to as a connector, comprises a first U-shaped prong and a second U-shaped prong. The phrase “U-shaped prong” refers to an element that forms a cavity that is defined by two side walls and a base. Unless otherwise specified, the phrase “U-shaped prong” includes prongs in which the opening of the “U” is larger, smaller or the same size and the distance between the side walls closer to the base. Additionally, although two sides of the cavity are defined by walls, the other two sides of the three-dimensional space that form the cavity may be open and not defined by any structure. By having two sides open, the device has the ability to be associated with a panel in the middle of an edge of the panel.

In some embodiments, the inner surfaces of the side walls are smooth and flat. In other embodiments, one, more than one or all of the inner surfaces may be irregularly shaped and/or textured. When the inner surfaces of the side walls are flat, they may form planes or non-planar surfaces that are parallel or substantially parallel to each other. In other embodiments, the inner surfaces of the side walls are not parallel and form planes or non-planar surfaces that are closer together as the planes move farther from the base of the cavity. Thus, in a U-shaped prong there may be an upper inner width and a lower inner width, wherein the upper inner width is smaller than the lower inner width. In some embodiments, in a plurality of U-shaped prongs or in each U-shaped prong there may be an upper inner width and a lower inner width, wherein the upper inner width is smaller than the lower inner width.

The “upper inner width” is the size of the space between the two side walls at the location that is farthest from the base of the cavity. In some embodiments, the tips of each of the side walls may be tapered or contain curved or angled surfaces that form a space between them that is wider than the narrowest space between the side walls as the side walls reach their ends. The phrase “upper inner width” as used herein refers to the distance between the side walls distal to the base of the cavity but not including any region of the tapering, curving or angles at the tips of the side walls.

In some embodiments the upper inner width is between 0.25 inches and 4.0 inches or between 0.5 inches and 2.0 inches or between 0.75 inches and 1.0 inches.

The “lower inner width” is the size of the space between the two side walls at the location that is proximal to the base of the cavity. Thus, if the base of the cavity is curved and the inner surfaces of the side walls are flat, the lower inner width is located in the region where the flat surfaces meet the curved surface. If the base of the cavity is not curved, then the lower inner width may be defined as largest width between the side walls, which may, for example, be located where each side wall forms its first angle with a surface that forms a side wall of the base of the cavity.

In some embodiments, the ratio of the upper inner width to the lower inner width of each U-shaped prong may be from 0.65:1 to 0.99:1; 0.75:1 to 0.99:1; 0.80:1 to 0.99:1; 0.80:1 to 0.85:1; 0.85:1 to 0.90:1; 0.90:1 to 0.95:1; or 0.95:1 to 0.99:1. As persons of ordinary skill in the art will readily appreciate, materials that can expand due to force and then return to their original shape without breaking more easily than other materials may allow for greater difference in the upper inner width and the lower inner width over a smaller length (or depth). Thus, if one wishes to create devices that have a greater ability to expand at their upper inner widths, then one may in some embodiments prefer to use plastics as opposed to steel.

The thickness and width of the walls of the device may be determined by the strength of the material and the application into which it will be used. The thickness refers to the distance from the inner surface of the cavity to the exterior of the device, whereas the width of the walls refers to the distance along the inner surface of the side wall perpendicular to the depth. In some embodiments, the side walls have a decreasing thickness as one moves from the region that defines the lower inner width to the region that defines the upper inner width. In other embodiments, the thickness of the walls is constant or substantially constant over the portion that corresponds to the sides of the prong. By way of non-limiting examples, the thickness of the walls of the sides of the cavity may be from 1/32 of an inch to 1 inch or from 1/16 of an inch to ¾ of an inch or from ⅛ of an inch to ½ of an inch or from ¼ of an inch to ⅓ of an inch. Also, by way of non-limiting examples, the width of the side wall may be uniform or irregular and from ¼ of an inch to 4 inches or from ½ of an inch to 3 inches or from 1 inch to 2 inches.

The base of a U-shaped prong may be smooth or rough and a regular or an irregular shape. Additionally, it may be rounded and e.g., be defined by an arc of a circle or ellipse or other complex curve, or contain two or more flat surfaces. Thus, by way of further example, the cavity may be formed by two of the sides of a hypothetical triangle or three of the sides of a hypothetical rectangle (e.g., a square) or four or fewer sides of a hypothetical pentagon or five or fewer sides of a hypothetical hexagon etc.

The depth of the cavity may be defined by an absolute measurement or in relation to another parameter of the cavity. For example, in some embodiments, the deepest part of the cavity may be from 1 to 4 inches or from 2 to 3 inches. In other embodiments, the depth may be defined as being from 1.5 to 4 times as large as the size of the upper inner width or from 2 to 5 or 2 to 3 times as large as the size of the upper inner width.

In some embodiments, the device contains at least two U-shaped prongs, at least three U-shaped prongs, at least four U-shaped prongs, at least five U-shaped prongs, at least six U-shaped prongs, at least seven U-shaped prongs, or at least eight U-shaped prongs. Thus, by way of non-limiting examples there may be two to six U-shaped prongs or two to four U-shaped prongs or exactly two, three, four, five, six, seven or eight U-shaped prongs. When there are two or more U-shaped prongs, each U-shaped prong may be referred to a first, second, third, fourth, fifth, sixth, seventh or eighth U-shaped prong, respectively. Each of the plurality of U-shaped prongs may have the same dimensions or two or fewer of the U-shaped prongs may have the same dimensions or all may have different dimensions.

Thus, by way of a non-limiting example in a device that has exactly two U-shaped prongs, each of the first U-shaped prong and the second U-shaped prong may form a cavity that has an upper inner width and a lower inner width, wherein the upper inner width is smaller than the lower inner width. Similarly, in a device that has exactly three U-shaped prongs, each of the first U-shaped prong, the second U-shaped prong and the third U-shaped prong may form a cavity that has an upper inner width and a lower inner width, wherein the upper inner width is smaller than the lower inner width.

Because the devices of the present invention exist in three dimensional space, there a many different orientations that the prongs may have relative to each other. Any two U-shaped prongs can be described by the angle between the hypothetical axes on which each prong is centered, and they can be further described by the rotation of the prongs relative to each other. In some embodiments, the device is sufficiently rigid that the angle between or among the U-shaped prongs remains constant and the entire device is made of the same materials. In other embodiments, the U-shaped prongs are connected by a memory retaining, semi-flexible element that permits user to vary the angle between and rotation of the U-shaped prongs. As persons of ordinary skill in the art will recognize, the memory retention feature should permit the device to stay in a fixed position when subjected to the force of the panels and any additional force to which it would be subjected during ordinary and customary uses of the device into which it is incorporated.

In various embodiments, the axis a first U-shaped prong and the axis of a second U-shaped prong may have an angle of between 15 degrees and 180 degrees from each other, between 30 degrees and 75 degrees from each other, between 45 degrees and 90 degrees from each other, between 60 degrees and 105 degrees from each other, between 75 degrees and 125 degrees from each other, between 90 degrees and 145 degrees from each other, between 105 degrees and 160 degrees from each other or between 120 degrees and 180 degrees from each other. When there are three or more prongs on a device, any two of them may have any of the aforementioned angles relative to each other. The term “axis” refers to the imaginary line that bisects the cavity of a prong between two side walls. Typically, the prongs will be symmetrical; however, unless otherwise specified they may also be asymmetrical, in which case the axis will be deemed to be the hypothetical ray that runs perpendicular to the lowest part of the base of the cavity.

The parameter of the rotation of the prongs relative to each other defines the rotation of the cavities formed by the prongs relative to each other. The effect of the rotation can be readily noticed when panels are inserted into the cavities. If there is no rotation of the prongs, then the length of the panels that sit within them would be parallel.

By contrast, if there are two prongs for which the axes form an angle of 90 degrees and there is a rotation of 90 degrees then the planes of the panels if extended would be at right angles relative to each other. If there are two prongs for which the axes form an angle of 180 degrees and there is a rotation of 90 degrees, then the planes of the panels, if extended, would also be oriented 90 degrees relative to each other. In some embodiments between any two prongs there is no rotation. In other embodiments, between any two prongs there is a rotation of 15 degrees to 175 degrees, 30 degrees to 150 degrees, 30 degrees to 90 degrees or 40 degrees to 75 degrees.

Thus, in some embodiments all of the prongs are oriented in the same plane, e.g., there may be two prongs that are oriented in the same plane, there may be three prongs and each is oriented in the same plane or there may be four prongs and each is oriented in the same plane. In one embodiments there are three prongs and the angle between the first U-shaped prong and the second U-shaped prong is 120 degrees or less, the angle between the second U-shaped prong and the third U-shaped prong is 120 degrees or less and the angle between the first U-shaped prong and the third U-shaped prong is 120 degrees or more. This embodiment may exist when the prongs are in the same plane or when only two of them are in the same plane and the third one is rotated, or when all are in different planes, i.e., there is an angle of rotation between each pair.

As persons of ordinary skill in the art will appreciate, as devices that contain three or more prongs are used, the number of possible combination of angles among the axis of the prongs and orientations of the prongs will increase. In some embodiments, there are four prongs wherein each prong is about 109.5 degrees from each other prong, i.e., the angles between any two prongs are all the same. By way of another example, there may be four prongs in the same plane, such that any one prong's axis is 90 degrees from two other prongs, and 180 degrees from the fourth prong. In still a further embodiment, there are six prongs oriented as follows: up, down, front, back, left and right, so that each prong's axis is ninety degrees from the axis of four other prongs. Optionally, the rotation component may be such that exactly four of these six prongs may be in one plane and the other two may be in a second plane.

The devices may be made from any material that is sufficiently strong for its intended use of holding panels together. Examples of materials include but are not limited to metals, such as gold, titanium, stainless steel, bronze and tin; metal alloys; compressed paper; wood; reinforced fiber; plastics; bioplastics; resins; polypropynol; polyethylene; bone; ceramic; carbon fiber; glass; nanotubes; and combinations thereof. In some embodiments where flexibility, strength and machinability are desired a connector may consist of, consist essentially of or comprise aluminum. By varying the thickness of the walls as described above, one can impart a sufficient balance of rigidity and flexibility to permit the opening of the cavity to expand when a panel is inserted yet retain stability.

The devices may be manufactured by any technique that is now know or that comes to be known and that a person of ordinary skill in the art would appreciate would be useful in connection with the present invention, including but not limited to extrusion, molding, die casting, investment casting, milling (e.g., CNC milling), injection molding, water jet cutting, laser cutting, pressing and stamp milling from a slab, extruding and then detailing and milling, when for example the device is made from aluminum, or casting when, for example, the device is made from casting.

The devices may further comprise at least one intermediary element that is located on an inner wall of at least one of a first U-shaped prong and a second U-shaped prong. An intermediary element is an element that may be permanently or reversibly associated with an inner wall of a prong. The intermediary element has a thickness and may cause a portion of or the entire cavity of a U-shaped prong of a device to become narrower. One or more intermediary elements may be used to line a portion of one inner side wall of a U-shaped prong, all of an inner side wall of a U-shaped prong, a portion of both inner side walls of a U-shaped prong or all of both inner side walls of a U-shaped prong, the inner base of the cavity or all of the inner said walls and the base. Furthermore, intermediary elements may be stacked on top of each other in order to narrow the size of the cavity further.

In addition to narrowing the cavity of a U-shaped prong of the device, the intermediary element may also impart increased friction when a panel is located within the device. In some embodiments, the intermediary element has a higher coefficient of friction than the inner wall of the U-shaped prong on which it is located.

The intermediary element may be associated with the device by any adhesive material that is now know or that comes to be known and that upon reading the present disclosure, a person of ordinary skill in the art would appreciate is useful in connection with the present invention. The adhesive may form a permanent association or a reversible association such that the intermediary element could be associated with the device and removed without adversely affected the integrity of either the device or the intermediary element. By way of example, the adhesive could be glue. In other embodiments, the intermediary element is affixed to a panel and not the device.

Examples of intermediary elements include but are not limited to those that comprise, consist essentially of or consist of one or more of fabric (e.g., cotton, or wool), plastic, metal, metal alloys, rubber, polypropylene, cork, rayon, paper, tape, glue or combinations thereof. In some embodiments, the intermediary element is fabric tape and is placed on a panel that is comprised of smooth wood panel. In other embodiments, the intermediary element is a polymer based substrate that is placed on a glass panel.

The intermediary element may have a uniform thickness or it may have a varying thickness. Ranges of thicknesses of the intermediary elements may be 0.005 to 0.025 inches, 0.001 to 0.002 inches or 0.002 to 0.025 inches. When the thickness of the intermediary element is variable, the intermediary element may, in some embodiments be applied such that is has greater thickness distal to the base of the cavity when applied to the cavity or distal to the edge of the panel when applied to the panel. If the intermediary element has variable thickness, the cavity of a U-shaped prong may in some embodiments have a uniform width, prior to attachment of the intermediary element if the intermediary element is attached to the device or prior to insertion of the panel if the intermediary element is attached to the panel. In some embodiments, the intermediary element may be compressed when the panel is nested in the device. The amount of compression may be up to 80%, for example 0-80% or 1-70% or 5-60% or 10-50% or 20-40%.

In some embodiments, the present invention provides a combination of one or more of the aforementioned devices and a plurality of panels. The plurality of panels and the plurality of devices may form one or more of a desk, a bed, a bookcase, a shelf, a table, a platform, a stool, a chair, a plant stand, or a stand for electronic equipment or a combination thereof and the plurality of panels are sized to reversibly nest in one or more of said plurality of devices. Other uses of the devices and panels include but are not limited to assembly of walls, shelters, counters and work surfaces. Furthermore, when no permanent or irreversible attachment mechanisms are used, the prongs and panels can be re-configured to form the same types of furniture with different configurations (e.g., cubbies that are six units high and one unit wide can be reconfigured to be three units high and two units wide), or to be used in different pieces of furniture (e.g., used in a shelve then used in a desk). As persons of ordinary skill in the art will readily appreciate when reconfiguring or creating different furniture pieces, one need not use the same number or same types of devices and panels.

In some embodiments, the panel may be flat or at least flat at the locations to which the devices may become associated. However, the present invention also encompasses embodiments in which the panel is not flat, e.g., curved, and in such cases the inner walls of the prongs of the devices would contain similar curvature to receive the panels over the relevant ranges.

The panels may consist of, consist essentially of or comprise any rigid or flexible material, e.g., cardboard or plastic that is sufficiently sturdy. Preferably, the material retains its structure when used for its intended purpose. These elements may be manufactured by methods that are now known or that come to be known and that a person of ordinary skill in the art would appreciate as being useful in connection with the present invention. The panel may contain one or more voids or depressions. These voids or depressions can serve as alignment elements for the prongs, and may be located on one face of the panel or on opposite faces. A prong may be inserted directly over the alignment element. The prong may contain no intermediary elements or one or more intermediary elements. Additionally or alternatively, in the void or depression in the panel one may insert an intermediary element that is a flexible material whose density and compressibility can vary in order to ensure a suitable fit with the prong that is to be associated with it. Thus, the intermediary element may render the site of association elastic, soft, malleable and/reformable.

In other embodiments, the present invention is directed to a combination of one or more of the aforementioned devices and a plurality of panels, wherein the panels comprise one or more intermediary elements, wherein the plurality of panels and the plurality of devices form one or more of a desk, a bed, a bookcase, a shelf, a table, a platform, a stool, a chair, a plant stand, or a stand for electronic equipment or a combination thereof and said plurality of panels are sized to reversibly nest in one or more of the plurality of devices.

When the devices are in use, the panels are inserted into the U-shaped cavities. In some embodiments, each panel (including any intermediary elements that may be present) may have a uniform thickness and be the same thickness or slightly greater than the upper inner width of the U-shaped prong into which it is inserted. Depending on the composition of the device, the panel and the intermediary element, the insertion of the panel may in some embodiments cause the device to expand, e.g., 0.01-2.0 percent or 0.01-0.10 percent or 0.10-1.0 percent or 1.0-2.0 percent. Thus, in some embodiments, the composition of the device and the panel are selected such that the cavity of the device expands rather than causing compression of the panel inserted therein and if there are any intermediary elements, any compression that does occur, occurs of within them.

When assembling a combination that uses intermediary elements that are to be affixed to panels, one should decide where to place the intermediary elements on the panels, and then center the connector on the intermediary element. These steps may be repeated until the desired number or panels and connectors are used. For any side of a board, it may be advantageous to use one, two, three, four or more connectors on one or more sides. The connectors may be evenly spaced from each other and/or the edges of the panels or unevenly spaced.

In embodiments in which there is only one U-shaped prong, there may also be one or more additional attachment mechanisms that are not U-shaped prongs. For example, there may be a nut and or bolt that enables attachment to another panel. This second attachment mechanism may be more permanent that the U-shaped prong. These additional attachment mechanisms may be used regardless of the number of U-shaped prongs. There also may be additional attachment mechanisms in the furniture that are not part of the connectors. By way of an example, a desk may be assembled using the devices and prongs of the present invention, as well as stabilization cables and thumb screws.

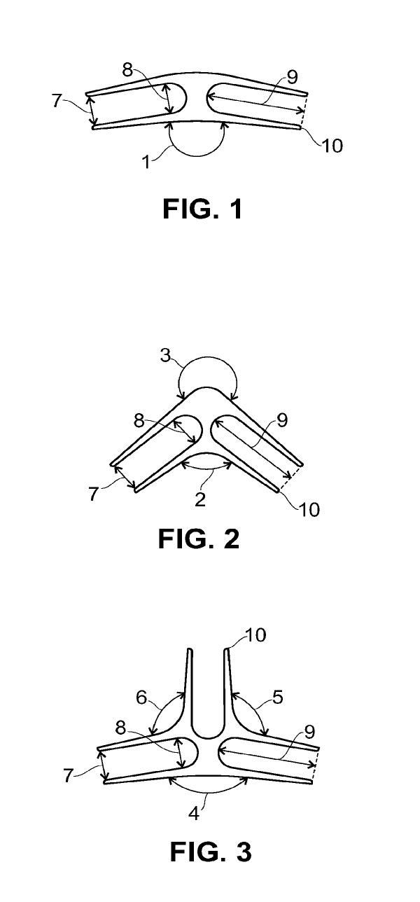

Various embodiments of the present invention may be further understood by reference to the accompanying figures. FIG. 1 shows a device that has two U-shaped prongs. The cavity of each prong is 2.3090 inches deep 9, has an upper inner width of 0.7575 inches 7 and has a lower inner width of 0.7700 inches 8. The tips 10 are rounded and the width at the tip of the cavity is greater than the upper inner width 7.

Each U-shaped prong may be symmetrical along a hypothetical axis. Where these axes intersect, the device has a width of 1.2570 inches, and the angle formed by these axes is 160 degrees 1. Because of the curvature of the device, the distance between to two tips that form the edge of the larger angle is 5.200 inches and the distance between to two tips that form the edge of the smaller angle is 4.887 inches.

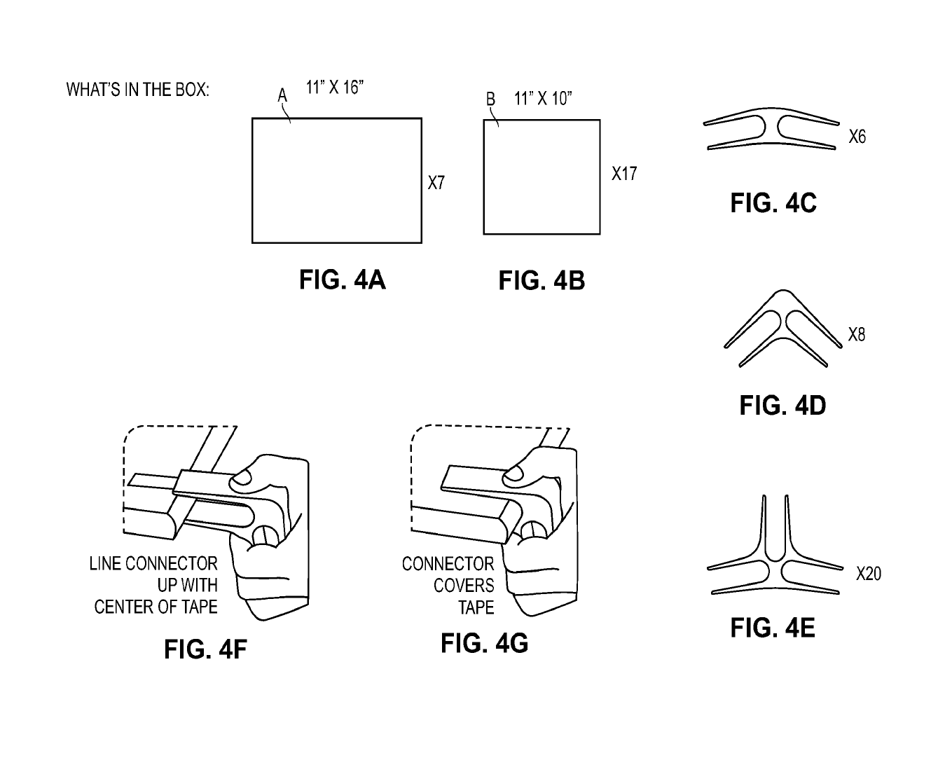

FIG. 2 represents another device of the present invention. The cavities are defined by the same parameters as in FIG. 1 (upper inner width 7, lower inner width 8, depth 9, and tips 10). However, the smaller angle between the cavities is only 100 degrees 2, and the large angle is 260 degrees 3. This causes other dimensions to change. Because of the curvature of the device, the distance between to two tips that form the edge of the smaller angle is 3.382 inches.

In both FIG. 1 and FIG. 2, the U-shaped prongs are not rotated relative to each other. Thus, the panels inserted into the prongs will maintain a consistent angle relative to each other over the surface of the panel.

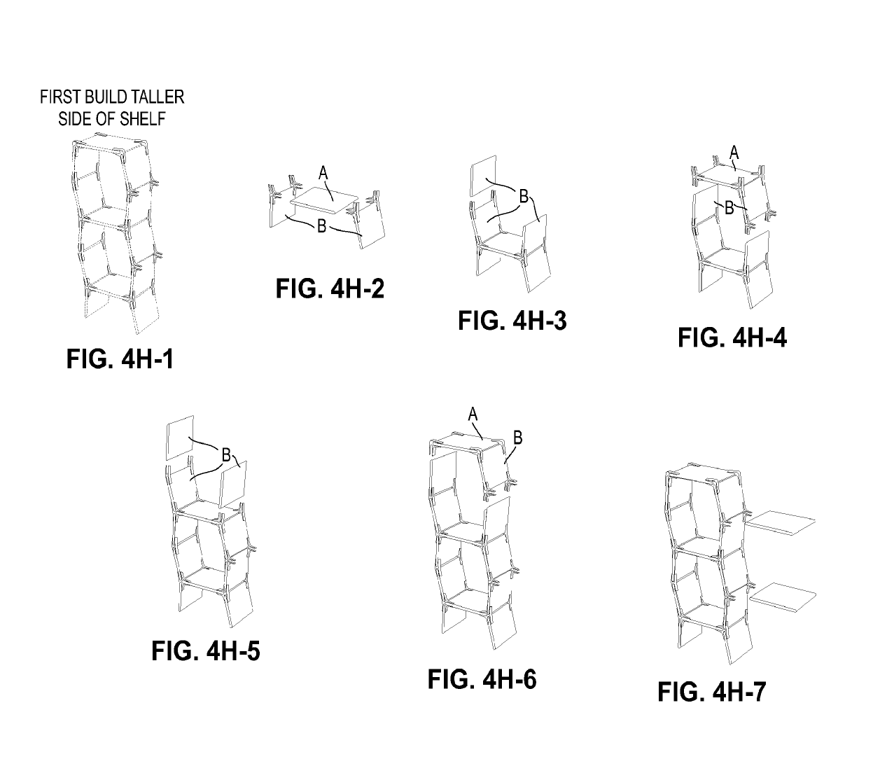

FIG. 3 is a representation of another device of the present invention. However, unlike in FIGS. 1 and 2, there are three U-shaped prongs. The cavities are defined according to the same parameters as FIGS. 1 and 2 (upper inner width 7, lower inner width 8, depth 9, and tips 10). The axis of the first U-shaped prong and the axis of the second U-shaped prong are 100 degrees apart 6. The axis of the second U-shaped prong and the third U-shaped prong are also 100 degrees apart 5. The axis of the first U-shaped prong and the third U-shaped prong are 160 degrees apart. All three prongs are in the same plane, i.e., they are not rotated relative to one another and between any two panels inserted into the prongs the angle between them remains constant over their surfaces.

By way of further non-limiting example, the devices shown in FIGS. 1 to 3 may have a part tolerance of 0.044+−, be one inch thick, be deburred, have a brushed finish and be anodized.

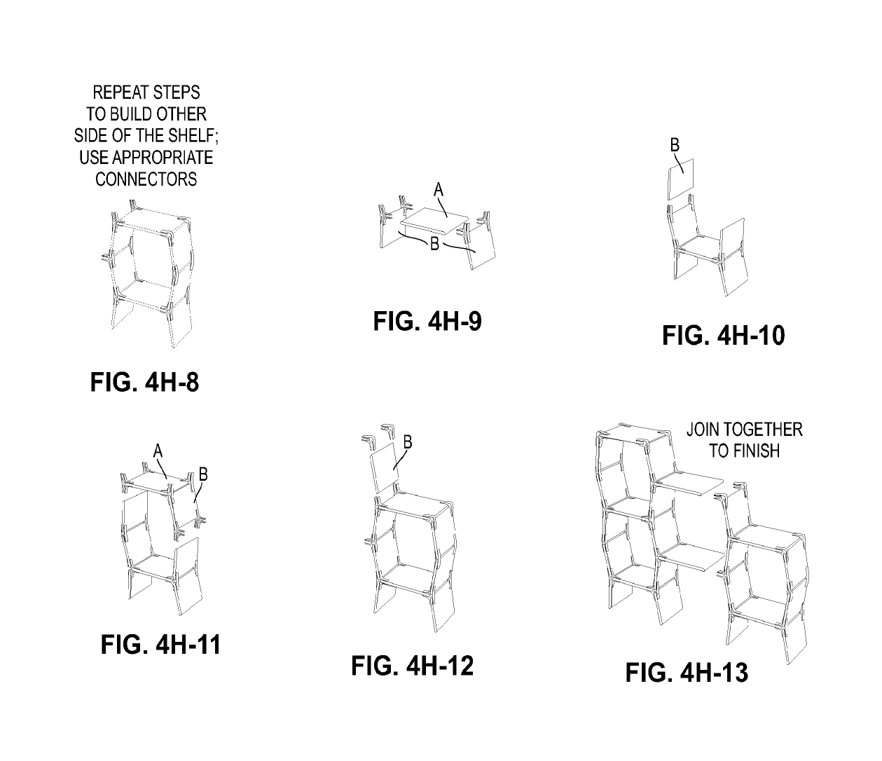

In various embodiments, the present invention is directed to a kit that comprises a plurality of devices, a plurality of panels and optionally, instructions for assembling the unassembled devices and panels. FIGS. 4A to 4H13 provide a representation of a kit and instructions for assembly of a combination of devices and panels. The kit contains: (A) seven panels that have faces with dimensions of 11 inches by 16 inches (“A size”) FIG. 4A; (B) seventeen panels that have faces with dimensions of 11 inches by 10 inches (“B size”), FIG. 4B; (C) six devices as illustrated by FIG. 1, FIG. 4C; (D) eight devices as illustrated by FIG. 2, FIG. 4D; (E) twenty devices as illustrated by FIG. 3, FIG. 4E. The panels may come with intermediary elements (e.g., tape) affixed at locations at which a device is to become associated with the panel. Optionally, the intermediary elements are supplied not already affixed to the panels and the instructions indicate where to place the tape, which may be at predetermined locations on the panels that are outlined or colored. FIG. 4F shows alignment of a device (connector) with an intermediary element (tape). FIG. 4G shows the device (connector) covering the tape shown in FIG. 4F.

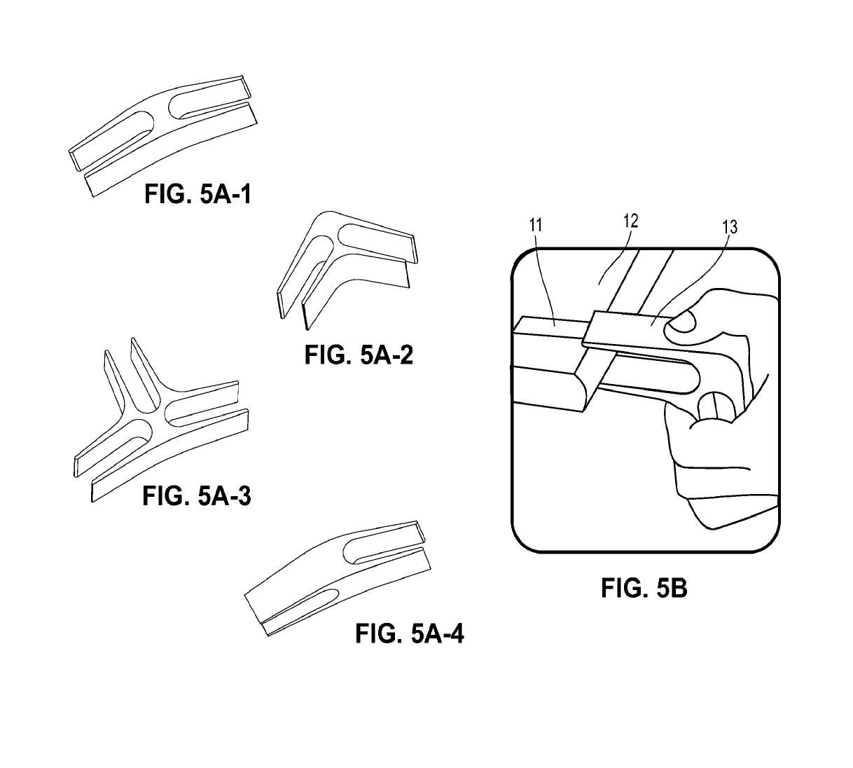

The instructions show that for the furniture shown, first one builds the taller side of the shelf, FIG. 4H-1. As FIG. 4H-2 shows, a consumer may start with two B size panels and to each of those panels affix two devices that have three U-shaped prongs each, and then connect the devices to an A size panel. FIG. 4H-3 shows the incorporation of three more B size panels and two devices of the type shown in FIG. 1. FIG. 4H-4 shows that addition of an A size panel connected to a B size panel, and six devices all of the type shown in FIG. 3. FIG. 4H-5 shows a continuation of the buildings of the shelves by the addition of three more B size panels and two more devices of the type shown in FIG. 1. FIG. 4H-6 shows the addition of one more A size panel and one more B size panel with six more devices. FIG. 4H-7 shows the addition of two additional A size panels. FIGS. 4H-8-4H-11 show the same steps as FIGS. 4H-1 of 4H-4 to begin forming the shorter side of the shelf. FIG. 4H-12 shows the addition of one more B size panel and two devices as shown in FIG. 2. FIG. 4H-13 shows how to join the larger side of the shelves to the smaller side of the shelves.

FIG. 5A-1 shows a perspective view of the device of FIG. 1. FIG. 5A-2 shows a perspective view of the device of FIG. 2. FIG. 5A-3 shows a perspective view of the device of FIG. 3. FIG. 5A-4 shows a device of the present invention with the orientation of the prongs rotated 90 degrees relative to each other. FIG. 5A-4 may be contrasted with FIG. 5A-1, which shows a device with the same angle between the prongs, but in which there has been no orientation of the prongs. FIG. 5B shows how to insert a device 13 over an intermediary element 11 on a panel 12.

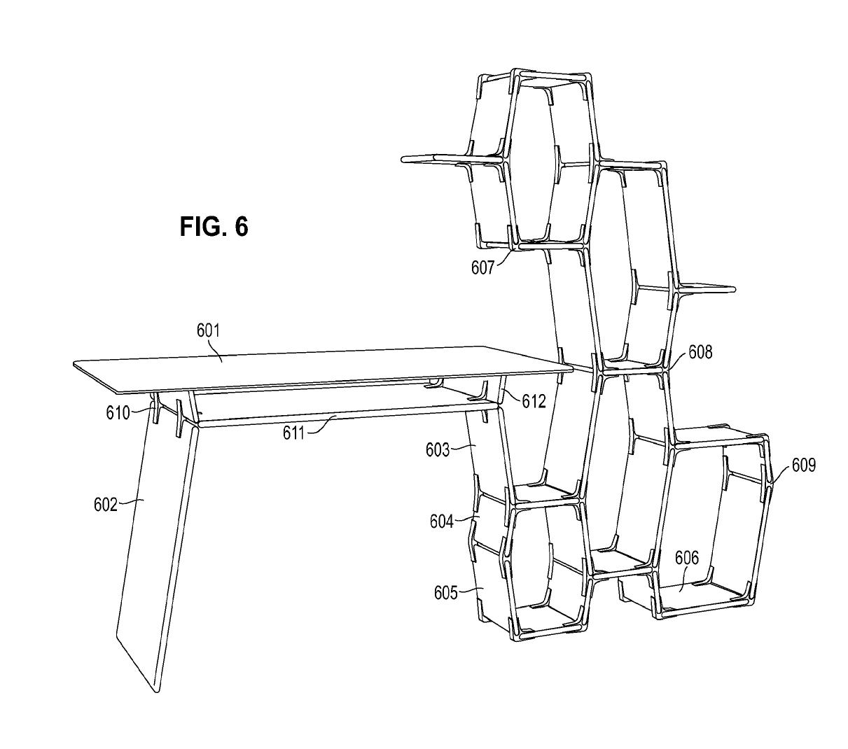

FIG. 6 shows a piece of furniture that forms a desk and shelves incorporating the devices and panels of the present invention. The desk contains a planar desktop 601 that is supported by two small panels 612, which are connected to each other through a horizontal panel 611 that runs parallel to the desktop. The left panel supporting the desk is connected by prongs 610 to a left leg 602. The right side of the desk in connected to a panel that through prongs is connected to a modular shelving system. In the modular shelving system there are panels of different sizes e.g., 603, 604, 605, and 606 that are connected through devices that have different configurations e.g., 607, 608, and 609. In FIG. 6, the devices and panels of the present invention are used exclusively, i.e., no additional hardware.

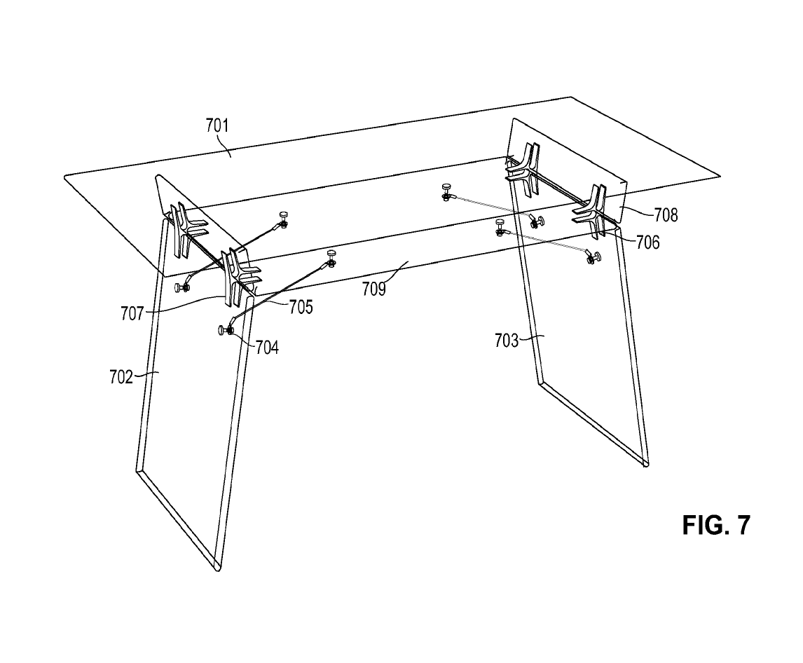

FIG. 7 shows a piece of furniture that forms a desk incorporating the devices and panels of the present invention, as well as additional hardware. In FIG. 7 there are two side panels 702 and 703 that form legs. The legs are attached to a horizontal panel 709 through connectors 706 and 707, as well as through the use of additional hardware comprising cables 705 and screws 704. The connectors 706 and 707 are also connected to additional panels that are connected to the desktop 701. Here, as in FIG. 6, the desktop may for example be made of glass and simply rest on its supports or be glued to it.

This application discusses specific embodiments of the present invention. The specific features described herein may be used in some embodiments, but not in others, without departing from the spirit and scope of the invention as set forth in the foregoing disclosure. However, unless otherwise specified or apparent from context, any feature described as being used in connection with any one embodiment, may be used in any other embodiment. Further, it will be appreciated by those of ordinary skill in the art that the illustrative examples do not define the metes and bounds of the invention.

What is claimed:

1. A device for connecting a plurality of panels, said device comprising a first U-shaped prong and a second U-shaped prong, wherein each of the first U-shaped prong and the second U-shaped prong comprises a cavity and two side walls and each of the first U-shaped prong and the second U-shaped prong has an upper inner width and a lower inner width, wherein the upper inner width is smaller than the lower inner width, and wherein the upper inner width is the size of the space between the two side walls at the location of the two side walls farthest from the base of the cavity and the lower inner width is the size of the space between the two side walls at a location that is proximal to the base of the cavity.

2. The device of claim 1, wherein the first U-shaped prong and the second U-shaped prong are oriented between 15 degrees and 180 degrees from each other.

3. The device of claim 1, wherein the ratio of the upper inner width to the lower inner width of each of the first U-shaped prong and the second U-shaped prong is from 0.75:1 to 0.99:1.

4. The device of claim 1, wherein the cavity of the first U-shaped prong has a depth, wherein the depth of the cavity of the first U-shaped prong is from 2 to 5 times as large as the size of the upper inner width of the first U-shaped prong and the cavity of the second U-shaped prong has a depth, wherein the depth of the cavity of the second U-shaped prong is from 2 to 5 times as large as the size of the upper inner width of the second U-shaped prong.

5. The device of claim 1, wherein said device further comprises a third U-shaped prong, wherein the third U-shaped prong comprises a cavity that has an upper inner width and a lower inner width, wherein the upper inner width is smaller than the lower inner width.

6. The device of claim 5, wherein the first U-shaped prong, the second U-shaped prong and the third U-shaped prong are not rotated relative to one another.

7. The device of claim 6, wherein the angle between the first U-shaped prong and the second U-shaped prong is 120 degrees or less, the angle between the second U-shaped prong and the third U-shaped prong is 120 degrees or less and the angle between the first U-shaped prong and the third U-shaped prong is 120 degrees or more.

8. The device of claim 5, wherein at least two of the first U-shaped prong, the second U-shaped prong and the third U-shaped prong are oriented in different planes.

9. A device for connecting a plurality of panels, said device comprising a U-shaped prong formed by two side walls and an additional attachment mechanism, wherein the U-shaped prong comprises a cavity that has an upper inner width and a lower inner width, wherein the upper inner width is smaller than the lower inner width, and wherein the upper inner width is the size of the space between the two side walls at the location of the two side walls farthest from the base of the cavity and the lower inner width is the size of the space between the two side walls at a location that is proximal to the base of the cavity.

10. The device of any of claim 1 further comprising at least one intermediary element that is located on an inner wall of at least one U-shaped prong.

11. The device of claim 10, wherein each U-shaped prong has at least one intermediary element, wherein the intermediary element has a higher coefficient of friction than the inner wall of the U-shaped prong on which it is located.

12. The device of claim 11, wherein each U-shaped prong has two intermediary elements.

13. The device of claim 12, wherein each intermediary element is reversibly associated with the device.

14. A combination comprising:
(a) a plurality of devices of any of claim 1; and
(b) a plurality of panels,
wherein said plurality of panels and said plurality of devices form one or more of a desk, a bed, a bookcase, a shelf, a table, a platform, a stool, a chair, a plant stand, or a stand for electronic equipment or a combination thereof and said plurality of panels are sized to reversibly nest in one or more of said plurality of devices.

15. A combination comprising:
(a) a plurality of devices of any of claim 1; and
(b) a plurality of panels, wherein said panels comprise one or more intermediary elements,
wherein said plurality of panels and said plurality of devices form one or more of a desk, a bed, a bookcase, a shelf, a table, a platform, a stool, a chair, a plant stand, or a stand for electronic equipment or a combination thereof and said plurality of panels are sized to reversibly nest in one or more of said plurality of devices.
